(19) United States
(12) Patent Application Publication
(10) Pub. No.: US 2026/0110372 A1
(43) Pub. Date: Apr. 23, 2026

(54) AUTOMATIC SHEETING-AND-TUBING LAYING ATTACHMENT

(71) Applicant: Tarpomatic, Inc., Canton, OH (US)

(72) Inventor: Michael Weston Slutz, Bolivar, OH (US)

(21) Appl. No.: 19/367,271

(22) Filed: Oct. 23, 2025

Related U.S. Application Data
(60) Provisional application No. 63/711,126, filed on Oct. 23, 2024.

(51) Int. Cl. F16L 1/024; C22B 3/04

(52) U.S. Cl. CPC F16L 1/0243; C22B 3/04

(57) ABSTRACT

An automatic sheeting-and-tubing system and attachment used to facilitate both application of various runs of tubing over an area of ground and application of sheeting to cover of the runs of tubing and the ground is disclosed. The automatic sheeting-and-tubing system and attachment can be attachable to moveable equipment to facilitate positioning and repositioning relative to the area of ground such as a leach field. Movement of the moveable equipment and deployment of the various runs of tubing and the sheeting affords positioning of the various runs of tubing and the sheeting over the leach field.

The present application claims the benefit of U.S. Provisional Application No. 63/711,126, filed October 23, 2024; all of which is incorporated by referenced herein.

### FIELD

The present disclosure is directed to an automatic sheeting-and-tubing system and attachment used to facilitate both application of various runs of tubing over an area of ground and application of sheeting to cover the runs of tubing and the ground. The automatic sheeting-and-tubing system and attachment can be attachable to equipment to facilitate positioning and repositioning relative to the area of ground

### BACKGROUND

Leach fields are examples of areas where even application of liquid and evaporation of the liquid applied thereto can be a problem. Leaching processes can be used to recover desirable metals from ores and recycled materials by applying a leaching solution thereto. For example, cyanide for gold and silver, and acids for copper can be used as leaching solutions, and these leaching solutions can be applied to the ore and/or material field to facilitate recovery of these metals as part of the leaching processes. To illustrate, crushed ores and/or recycled materials containing such desirable metals are deposited in a leach field spread over an impermeable material. The leaching solutions are then applied to the ore and/or material field to react chemically with the desirable metals in the crushed ores and/or recycled materials. The chemical reacts dissolve the desirable metals in the leaching solution, and the leaching solution can be collected and drained from the impermeable material under the leach field. Thereafter, the desirable metals can be extracted from the leaching solution using chemical processes.

There is a need to address two problems that can arise when applying the leaching solution to the leach field. First, even application of the leaching solution to the leaching field can be difficult, and evaporation of the leaching solution can interfere with the leaching process. The automatic sheeting-and-tubing system according to the present disclosure can address these problems via application of various runs of tubing over the leach field to provide for substantially even application of the leaching solutions, and application of sheeting to cover the runs of tubing and the leach field to inhibit evaporation of the leaching solutions. The automatic sheeting-and-tubing attachment according to the present disclosure can be attached to equipment such as to a blade of a bulldozer to facilitate positioning and repositioning relative to the leach field.

### SUMMARY

The techniques of this disclosure generally relate to an automatic sheeting-and-tubing system and attachment used to facilitate both application of various runs of tubing over an area of ground and application of sheeting to cover of the runs of tubing and the ground

In one aspect, the present disclosure contemplates n automatic sheeting-and-tubing laying attachment including a first end and an opposite second end; a frame extending between the first end and the second end of the automatic sheeting-and-tubing laying attachment, a first adjustable attachment attached to and extending upwardly from the frame, and a second adjustable attachment attached to and extending upwardly from the frame; a first portion of a support platform portion attached to a lower portion of the frame adjacent the first end of the automatic sheeting-and-tubing laying attachment; a second portion of the support platform portion attached to the lower portion of the frame adjacent the second end of the automatic sheeting-and-tubing laying attachment; a first portion of a support truss portion attached to an upper portion of the frame adjacent the first end of the automatic sheeting-and-tubing laying attachment; a second portion of the support truss portion attached to the upper portion of the frame adjacent the second end of the automatic sheeting-and-tubing laying attachment; a first spool wound with sheeting rotatably attached relative to the first portion and the second portion of the support platform portion; a second spool wound with a plurality of runs of tubing rotatably attached relative to the first portion and the second portion of the support truss portion; a first portion of a capture-and-release assembly attached to at least one of the frame and the first portion of the support platform portion at the first end, the first portion of the capture-and-release assembly being engageable and disengageable to the first spool to facilitate capture and release of a first end portion of the first spool; a second portion of the capture-and release-assembly attached at least one of the frame and to the second portion of the support platform portion at the second end, the second portion of the capture-and-release assembly being engageable and disengageable to the first spool to facilitate capture and release of a second end portion of the first spool; a spool-drive assembly attached to one of the first and second portions of the capture-and-release assembly and engageable to a corresponding one of the first end portion and the second end portion of the first spool, the spool-drive assembly being actuatable to rotate the first spool to unfurl or furl the sheeting therefrom; where, when portions of each of the plurality of runs of tubing are attached to the sheeting, rotation of the first spool via actuation of the spool-drive assembly unfurls and furls both the sheeting from the first spool and the runs of tubing from the second spool.

In another aspect, the present disclosure contemplates an automatic sheeting-and-tubing laying attachment including a first end and an opposite second end; a frame extending between the first end and the second end of the automatic sheeting-and-tubing laying attachment; a support platform portion attached to a lower portion of the frame; a support truss portion attached to an upper portion of the frame; a first spool wound with sheeting rotatably attached relative to the support platform portion; a second spool wound with a plurality of runs of tubing rotatably attached relative to the support truss portion; a first portion and a second portion of a capture-and-release assembly attached to at least one of the frame and the support platform portion, the first and second portions of the capture-and-release assembly being engageable and disengageable to the first spool to facilitate capture and release of a first end portion and a second end portion, respectively, of the first spool, each of the first and second portions of the capture-and release-assembly including an actuatable arm and an actuatable jaw, each of the actuatable arms being attached relative to the support platform portion and being moveable between a lower first position and an upper second position, and each of the actuatable jaws being attached to a corresponding one of the actuatable arms and being moveable between a first disengaged position and a second engaged position; a spool-drive assembly attached to one of the first and second portions of the capture-and-release assembly and engageable to a corresponding one of the first end portion and the second end portion of the first spool, the spool-drive assembly being actuatable to rotate the first spool to unfurl or furl the sheeting therefrom; where, when the actuatable arms are in the lower first position, the first end portion of the first spool can be rolled onto the actuatable arm of the first portion of the capture-and-release assembly, the second end portion of the first spool can be rolled onto the actuatable arm of the second portion of the capture-and-release assembly, and, after receipt of the first and second end portions of the first spool on the actuatable arms, each of the actuatable jaws can be moved from the first disengaged position to the second engaged position to hold the first and second end portions relative to the actuatable jaws; where, after engagement of the actuatable jaws, the actuatable arms can be moved from the lower first positions to the upper second positions thereof; and where, when portions of each of the plurality of runs of tubing are attached to the sheeting, rotation of the first spool via actuation of the spool-drive assembly unfurls and furls both the sheeting from the first spool and the runs of tubing from the second spool.

In yet another aspect, the present disclosure contemplates a method of using an automatic sheeting-and-tubing laying attachment including attaching an automatic sheeting-and-tubing laying attachment to mobile equipment; moving the automatic sheeting-and-tubing laying attachment relative to a leach field using the mobile equipment; during the moving of the automatic sheeting-and-tubing laying attachment, rotating a first spool wound with sheeting in a first direction to deploy the sheeting therefrom over the leaching field; during the moving of the automatic sheeting-and-tubing laying attachment and the rotating of the first spool, rotating a second spool wound with various runs of tubing in a first direction to deploy the various runs of tubing under the sheeting deployed from the first spool and over the leaching field; and after deployment of the sheeting and the runs of tubing, expelling leaching solution from each of the runs of tubing onto the leaching field to dissolve desirable metals from crushed ore and/or recycled materials forming the leaching field; where the automatic sheeting-and-tubing laying attachment includes a spool-drive assembly engaged to at least one end of the first spool, and actuation of the spool-drive assembly rotates the first spool to deploy the sheeting therefrom; where the various runs of tubing are attached to the sheeting, and the deployment of the sheeting via the moving of the automatic sheeting-and-tubing laying attachment and the actuation of the spool-drive assembly also pulls the various runs of tubing from the second spool; and where each run of the various runs of tubing are spaced from one another under the sheeting.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a top, front, perspective view of an automatic sheeting-and-tubing system and attachment according to an embodiment of the present disclosure depicting unfurling of a run of tubing and sheeting covering the run of tubing;

FIG. 2 is a bottom, rear perspective view of the automatic sheeting-and-tubing system and attachment of FIG. 1 depicting the unfurling of the run of the tubing and the sheeting;

FIG. 3 is a bottom, front perspective view of the automatic sheeting-and-tubing system and attachment of FIG. 1 depicting the unfurling of the run of the tubing and the sheeting;

FIG. 4 is a front elevational view of the automatic sheeting-and-tubing system and attachment of FIG. 1 depicting the unfurling of the run of the tubing and the sheeting;

FIG. 5 is a top plan view of the automatic sheeting-and-tubing system and attachment of FIG. 1 depicting the unfurling of the run of the tubing and the sheeting;

FIG. 6 is a bottom plan view of the automatic sheeting-and-tubing system and attachment of FIG. 1 depicting the unfurling of the run of the tubing and the sheeting;

FIG. 7 is a bottom, side, perspective view of a first end portion of the automatic sheeting-and-tubing system and attachment of FIG. 1 depicting the unfurling of the run of the tubing and the sheeting;

FIG. 8 is a top, side, perspective view of the first end portion of the automatic sheeting-and-tubing system and attachment of FIG. 1 depicting the unfurling of the run of the tubing and the sheeting;

FIG. 9 is a bottom, side, perspective view of a second end portion of the automatic sheeting-and-tubing system and attachment of FIG. 1 depicting the unfurling of the run of the tubing and the sheeting; and

FIG. 10 is a top, side, perspective view of the second end portion of the automatic sheeting-and-tubing system and attachment of FIG. 1 depicting the unfurling of the run of the tubing and the sheeting.

### DETAILED DESCRIPTION

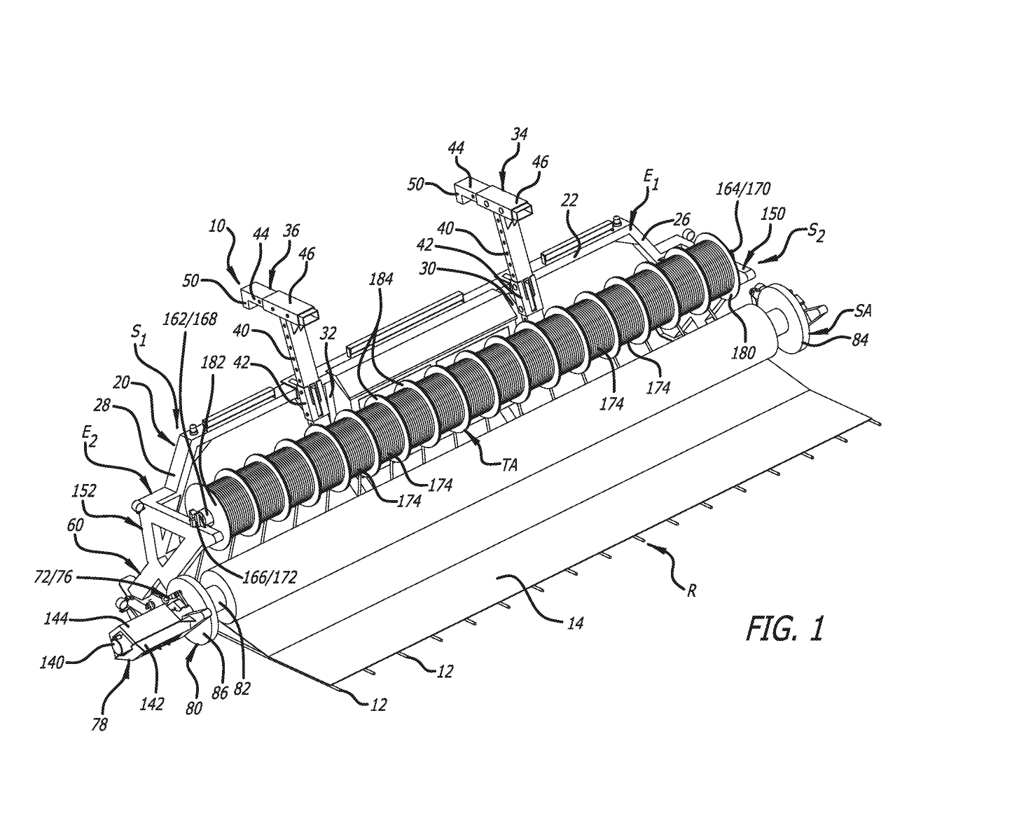

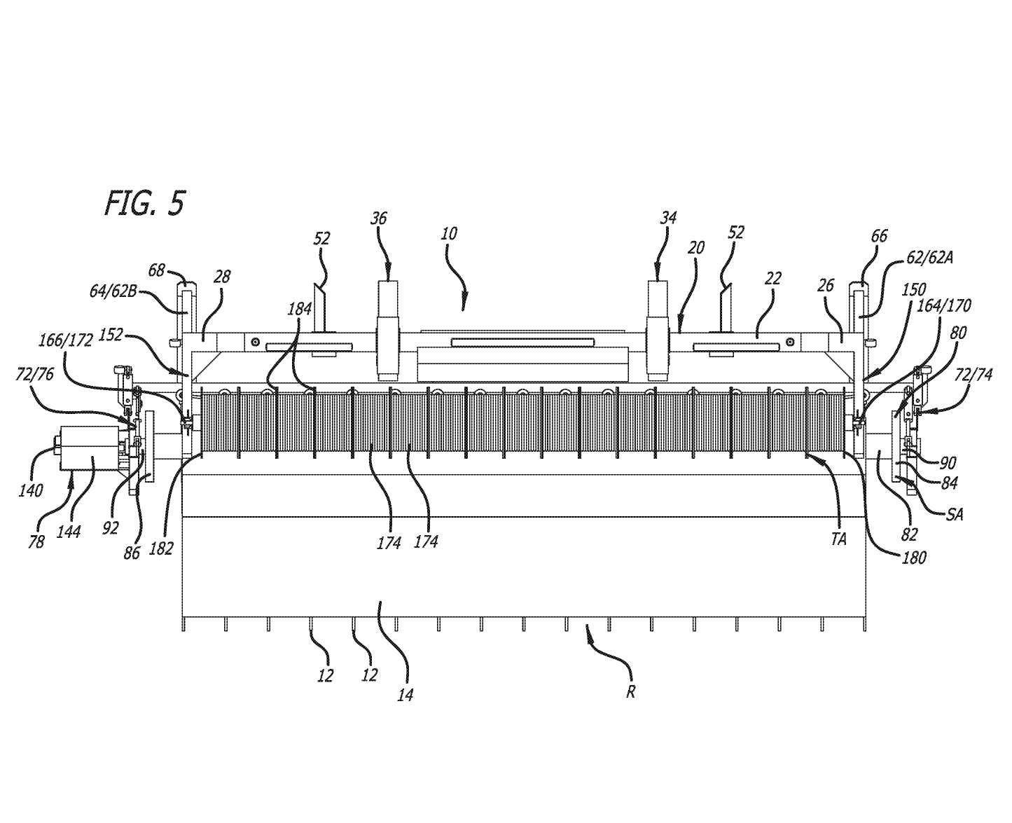

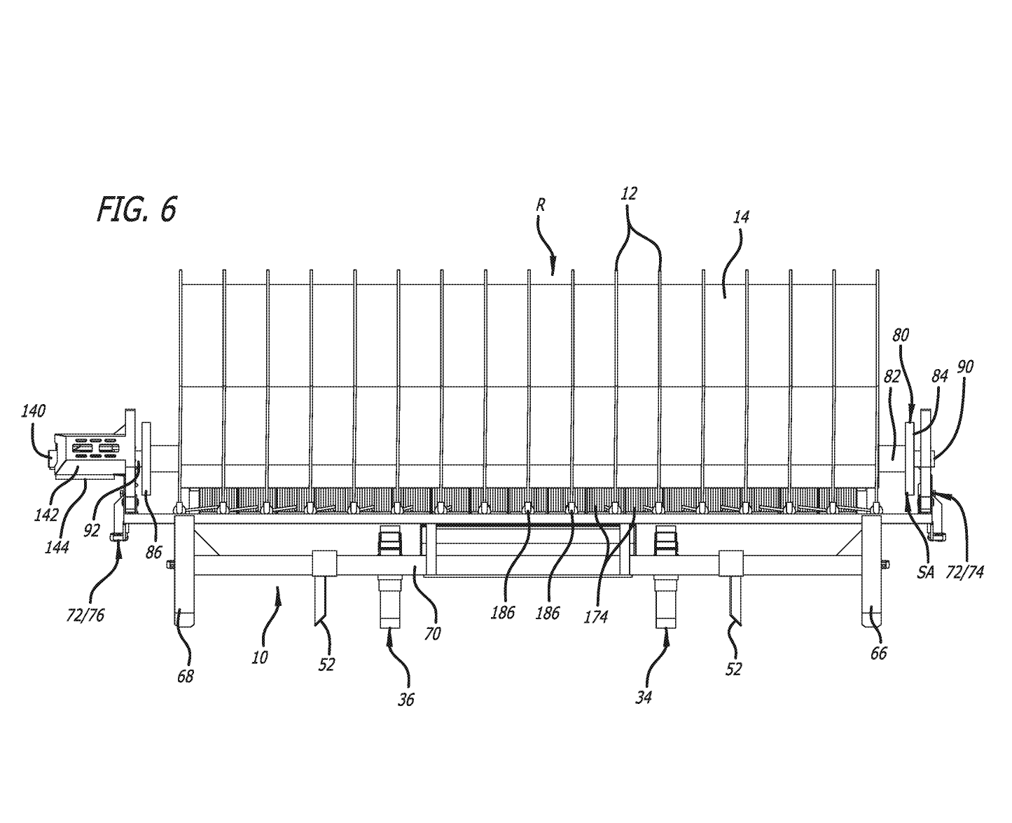

As depicted in FIGS. 1-10, an automatic sheeting-and-tubing laying system and attachment according to an embodiment of the present disclosure is generally indicated by the numeral 10. The attachment 10 can be attached to a blade of a bulldozer (not shown), and the blade can be used to raise and lower the attachment 10, and the bulldozer itself can be used to position and reposition the attachment 10 relative to a particular area of ground. During such movement, the attachment 10 can be used to deploy, for example, various parallel or substantially parallel runs R of tubing 12 (FIGS. 1-6) over the particular area of ground, and deploy sheeting 14 over the runs R of the tubing 12 and the particular area of ground. In doing so, the runs R of tubing 12 are applied over the area of ground, and the sheeting 14 is applied to cover the runs of tubing 12. As discussed below, the runs R of the tubing 12 can be permeated and/or perforated with holes for use as liquid soaking drip lines to facilitate application of liquid to the particular area of ground, and the sheeting 14 can be used to significantly reduce evaporation of the liquid. After use of the runs R of the tubing 12 and the sheeting 14 is complete, the attachment can be used to remove both the runs R of the tubing 12 and the sheeting 14. In some instances, the attachment can be used to deploy the runs R of the tubing 12 and the sheeting 14 to facilitate application of liquids to a mining leach field composed of detritus from mining to facilitate removal of desirous elements from the detritus.

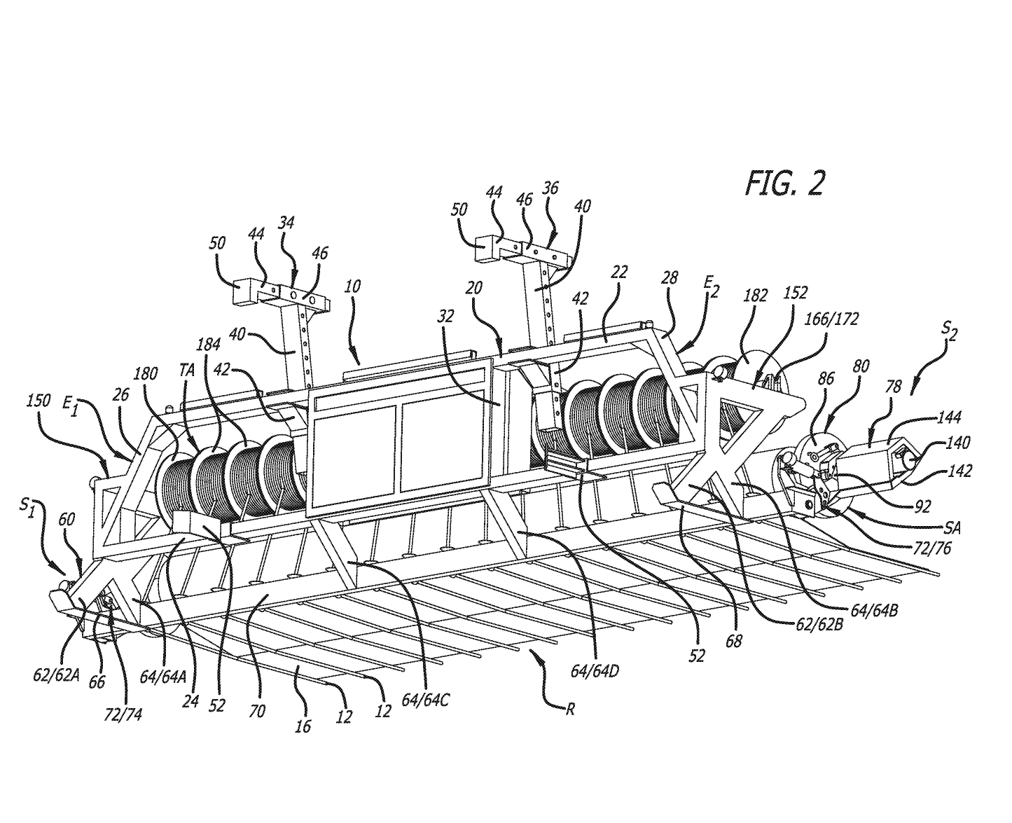

The attachment 10, as depicted in FIG. 2, can include a frame 20 including an upper first horizontal member 22, a lower second horizontal member 24, a first side member 26 , a second side member 28, a first inner member 30, and a second inner member 32. Furthermore, as depicted in FIGS. 1-3, the frame 20 can include a blade side S1 and a non-blade side S2, and can be used to provide rigidity to the attachment 10 and support various components of the attachment 10. The first side member 26 can be provided adjacent a first end E₁ of the attachment 10, the second side member 28 can be provided adjacent a second end E₂ of the attachment 10, and the upper first horizontal member 22 and the lower second horizontal member 24 can extend between the first side member 26 and the second side member 28. Additionally, the first inner member 30 and the second inner member 32 can extend between the upper first horizontal member 22 and the lower second horizontal member 24, and can reinforce a central portion of the frame 20.

As depicted in FIGS. 1 and 2, the attachment 10 can include a first adjustable blade attachment 34 attached to the upper first horizontal member 22 proximate the first inner member 30, and a second adjustment blade attachment 36 attached to the upper first horizontal member 22 proximate the second inner member 32. Each of the first adjustable blade attachment 34 and the second adjustable blade attachment 36 can include a first vertical support post 40, a first collar portion 42, a second horizontal post 44, and a second collar portion 46. The first collar portions 42 of each of the first adjustable blade attachment 34 and the second adjustable blade attachment 36 can be attached to the upper first horizontal member 22, and the first vertical support posts 40 can be adjusted upwardly and downwardly relative to the corresponding first collar portions 42. The second collar portions 46 of each of the first adjustable blade attachment 34 and the second adjustable blade attachment 36 can be attached to upper portions of the first vertical support posts 40, and the second horizontal support posts 44 can be adjusted inwardly and outwardly relative to the corresponding second collar portions 46.

Adjustment of the first vertical support posts 40 and the second horizontal support posts 44 allow the first adjustable blade attachment 34 and the second adjustable blade attachment 36 to be sized to facilitate attachment of the attachment 10 to differently-sized bulldozer blades. Additionally, as depicted in FIGS. 1 and 2, hook portions 50 can be provided on ends of the second horizontal support posts 44 on the blade side S2 to hang the attachment 10 from the blade of the bulldozer, and spacer portions 52 can be attached to the lower second horizontal 24 on the blade side S2 to contact the blade to maintain spacing of the attachment 10 relative to the blade.

A support platform portion 60, as depicted in FIG. 2, can space the frame 20 from the ground. The support platform portion 60 can include first struts 62 attached to and extending downwardly and outwardly on the blade side S1 from the lower second horizontal member 24, and second struts 64 attached to and extending downwardly and outwardly on the non-blade side S2 from the lower second horizontal member 24. As depicted in FIG. 2, the first struts 62 include a strut 62A provided adjacent the first end E₁ and a strut 62B provided adjacent the second end E₂. Furthermore, as depicted in FIG. 2, the second struts 64 include a strut 64A provided adjacent the first end E₁, a strut 64B provided adjacent the second end E₂, a strut 64C provided adjacent the first inner member 30, and a strut 64D provided adjacent the second inner member 32. The struts 62A and 64A can form a first end portion of the support platform portion 60 adjacent the first end E₁, and the struts 62B and 64B can form a second end portion of the support platform portion 60 adjacent the first end E₂. Additionally, a first skid plate 66 can be provided between the strut 62A and the strut 64A, and a second skid plate 68 can be provided between the strut 62B and the strut 64B. The first skid plate 66 and the second skid plate 68 can afford slidable movement of the attachment over the ground.

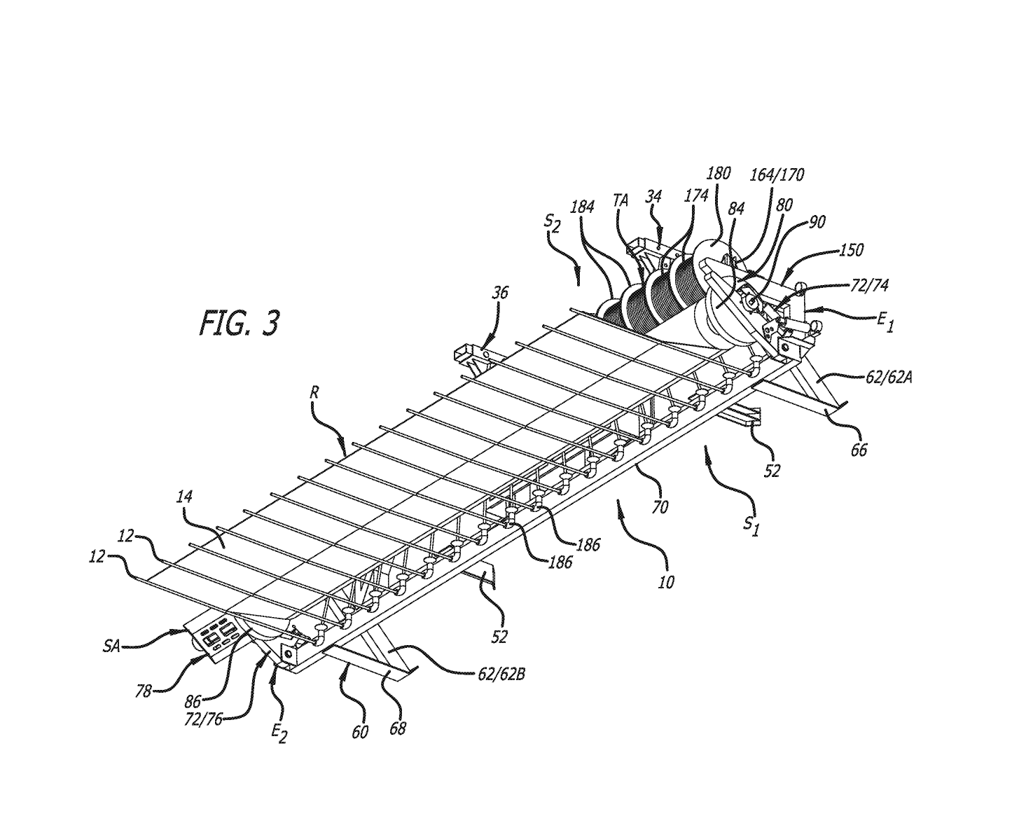

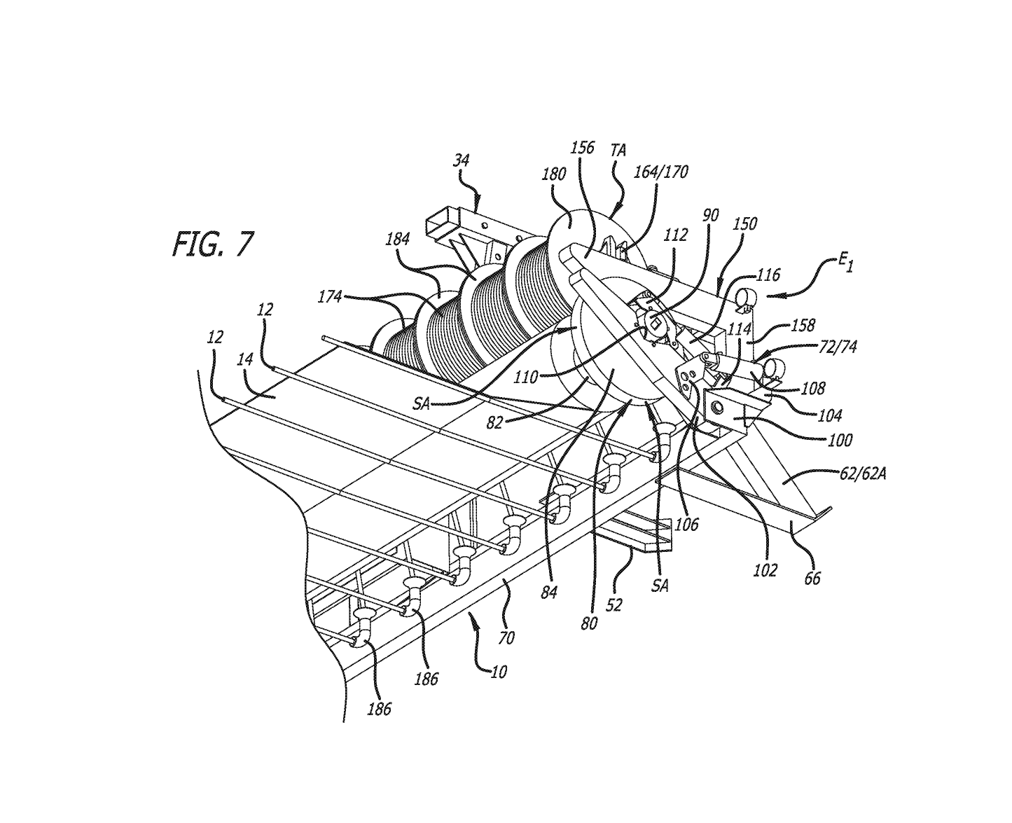

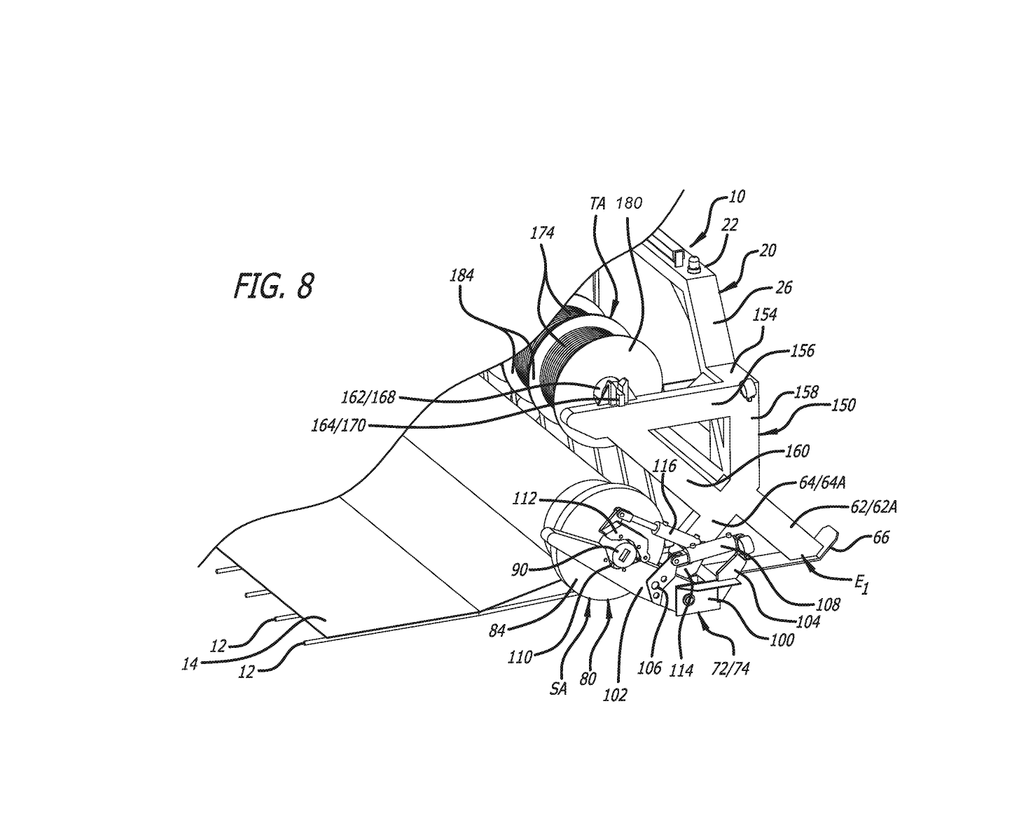

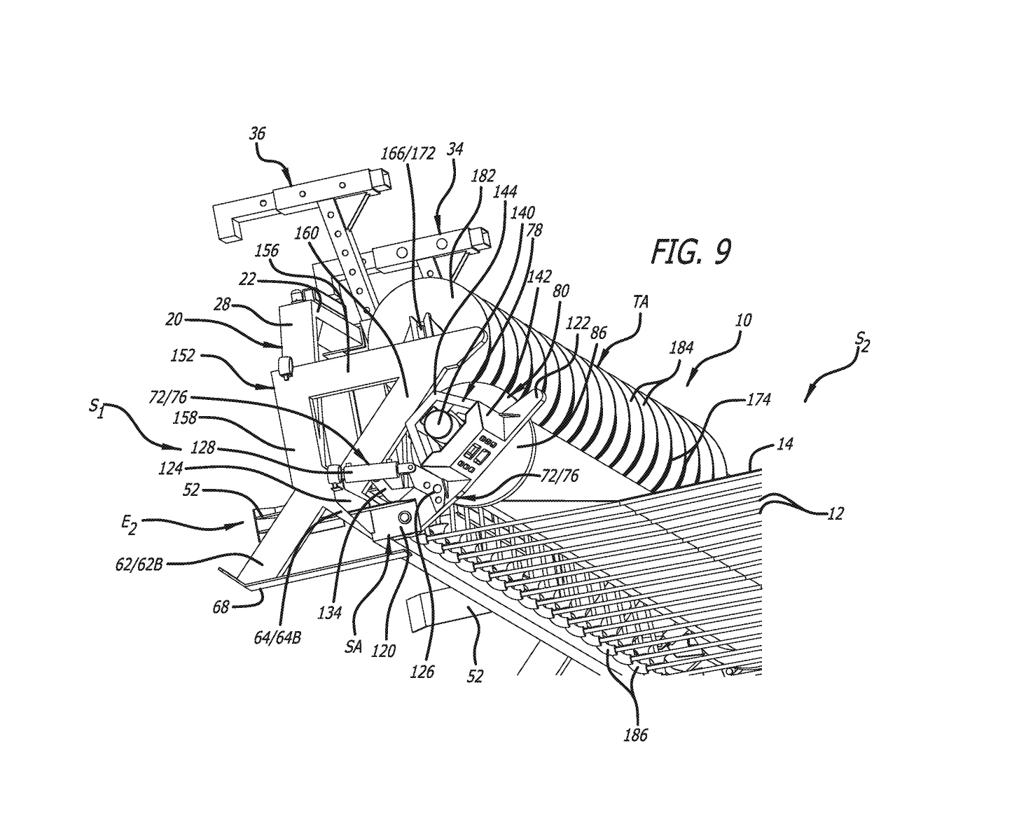

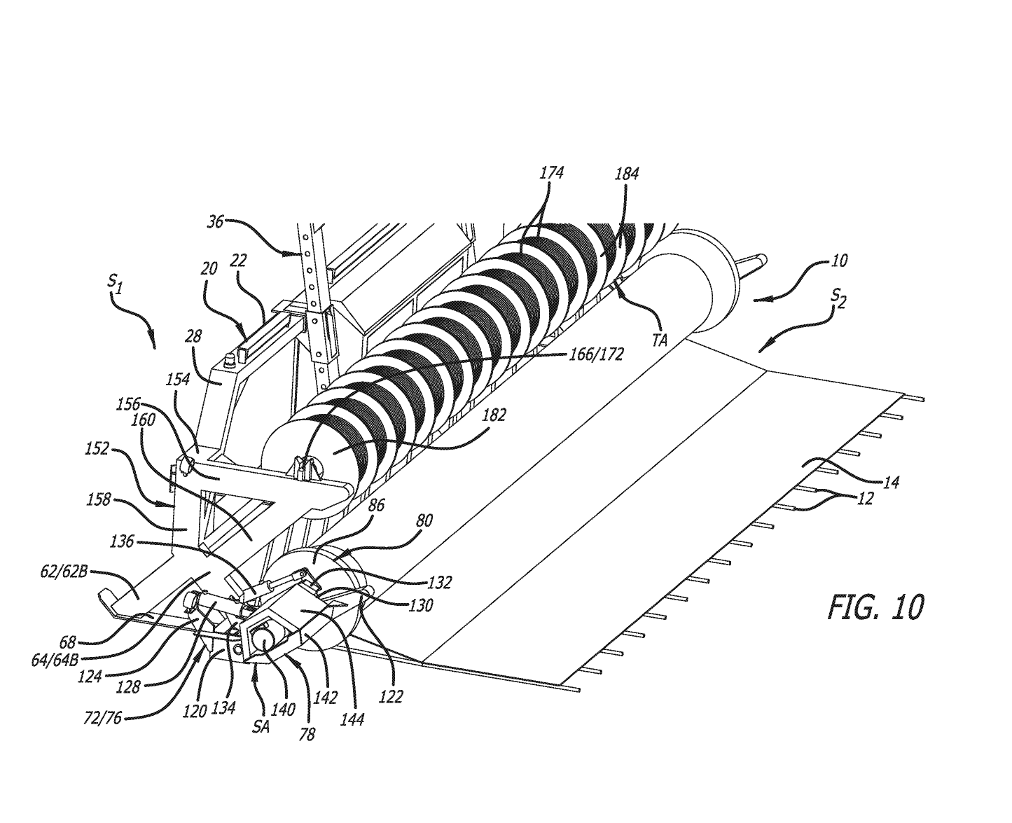

A support member 70 (FIGS. 2 and 3) of the support platform portion 60, can be attached to ends of the second struts 64 opposite from the lower second horizontal member 24, and the support member 70 can be used to support portions of a sheeting applicator SA (FIGS. 1-10) of the attachment 10 having a capture-and-release assembly 72 (including a first spool-capture portion 74 (FIGS. 7 and 8) and a second spool-capture portion 76 (FIGS. 9 and 10)), a spool-drive assembly 78, and a first spool (or mandrel) 80. The first spool 80 can be wound with the sheeting 14. As discussed below, the capture-and-release assembly 72 is configured to capture and release the first spool 80, and the spool-drive assembly 78 is configured to rotate the first spool 80 so that the sheeting 14 can be unrolled from or rolled onto the first spool 80.

The capture-and-release assembly 72 can be locked and unlocked to facilitate capturing and releasing of the first spool 80. To that end and as discussed below, the first spool-capture portion 74 and the second spool-capture portion 76 of the capture-and-release assembly 72 can each include sets of locking jaws that are engageable to capture the first spool 80 and disengageable to release the first spool 80. And the spool-drive assembly 78 can be engaged and disengaged to the first spool 80 to respectively facilitate rotation of the first spool 80 when the capture-and-release assembly 72 is locked and the first spool 80 captured, and facilitate capture and release of the first spool 80 when the capture-and-release assembly 72 is unlocked.

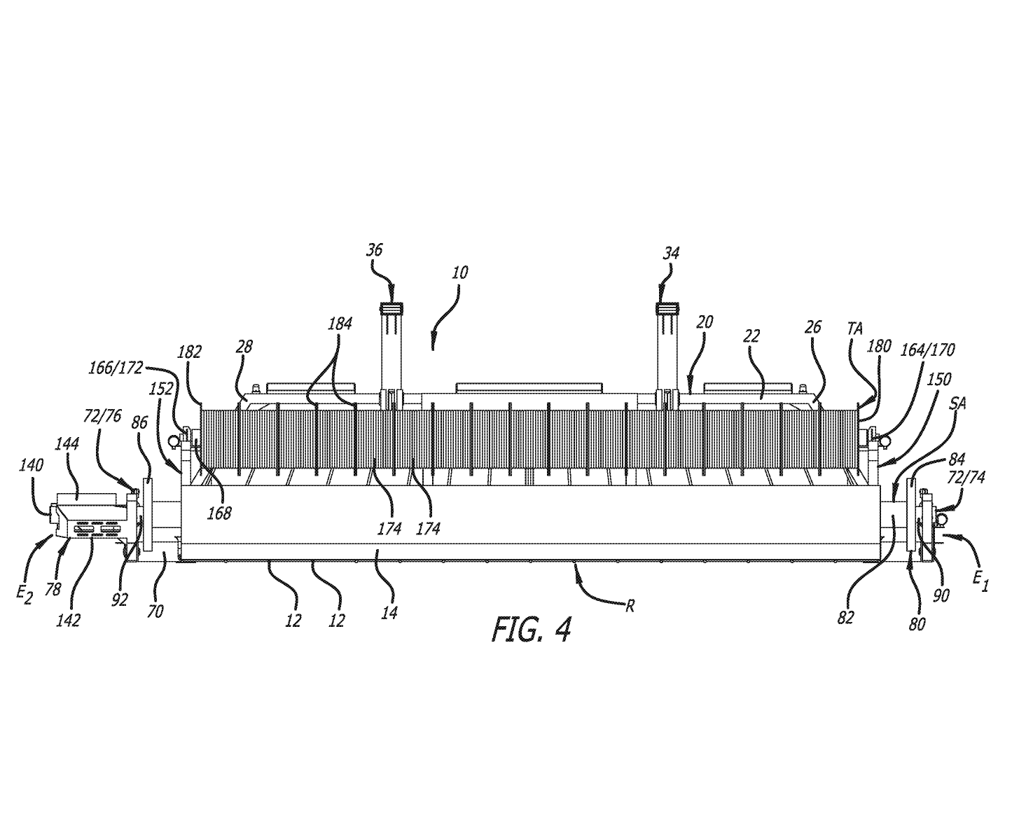

The first spool 80, as depicted in FIG. 1, can include a central portion 82, a first spool end portion 84, and a second spool end portion 86. The central portion 82 can be cylindrical or substantially cylindrical, and be configured to receive sheeting 14 wound therearound. Furthermore, the first spool end portion 84 and the second spool end portion 86 can each be cylindrical or substantially cylindrical, be formed of steel plating or bar stock, and have outer diameters larger than the outer diameter of the central portion 82. The first spool end portion 84 and the second spool end portion 86 can serve in preventing the sheeting 14 from winding off the first spool 80 during unrolling and rolling thereof. Additionally, as depicted in FIG. 4, the first spool 80 can include a first spindle portion 90 and a second spindle portion 92 attached to the first spool end portion 84 and the second end portion 86, respectively. The first spindle portion 90 and the second spindle portion 92 can each be cylindrical or substantially cylindrical, be formed of steel plating or bar stock, and have outer diameters smaller than the outer diameters of the first spool end portion 84 and the second spool end portion 86. The first spindle portion 90 can be received in the first spool-capture portion 74 of the capture-and-release assembly 72, the second spindle portion 92 can be received in the second spool-capture portion 76 of the capture-and-release assembly 72, and each of the first spindle portion 90 and the second spindle portion 92 can serve as axles facilitating rotation of the first spool 80 relative to portions of the attachment 10.

The first spool-capture portion 74 can be attached to the frame 20 and/or the first end portion of the support platform portion 60 adjacent the first end E₁. As depicted in FIGS. 7 and 8, the first spool-capture portion 74 can include a first plate portion 100 attached to an end of the support portion 70 at the first end E₁. The first plate portion 100 can pivotally support a first arm portion 102 of the first spool-capture portion 74 that is moveable between a first downward position and a second upward position. A first bracket portion 104 of the first spool-capture portion 74 can be attached to the first plate portion 100, a second bracket portion 106 of the first spool-capture portion 74 can be attached to the first arm portion 102, and a first actuator 108 of the first spool-capture portion 74 can be attached to and extend between the first bracket portion 104 and the second bracket portion 106. Actuation of the first actuator 108 can be used to move the first arm portion 102 between the first downward position and the second upward position. When in the first downward position, the first spindle portion 90 can be rolled up the first arm portion 102 and ultimately received in a first indentation 110 formed in the first arm portion 102. Thereafter, the first arm portion 102 can be moved from the first downward position to the second upward position, and the first spool-capture portion 74 can be further actuated to capture the first spindle portion 90 using a first locking jaw 112 of the first spool-capture portion 74. To that end, the first locking jaw 112 can be pivotally attached to the first arm portion 102, a third bracket portion 114 of the first spool-capture portion 74 can be attached to the first arm portion 102, and a second actuator 116 of the first spool-capture portion 74 can be attached to and extend between the first locking jaw 112 and the third bracket portion 114. Actuation of the second actuator 116 can be used to move the first locking jaw 112 from a disengaged position to an engaged position to capture the first spindle portion 90. With the first arm portion 102 in the second upward position and the first locking jaw 112 engaged, the first spindle portion 90 can be rotated in the first indentation 110 between the first arm portion 102 and the first locking jaw 112.

The second spool-capture portion 76 can be attached to the frame 20 and/or the second end portion of the support platform portion 60 adjacent the first end E₂. As depicted in FIGS. 9 and 10, the second spool-capture portion 76 can include a second plate portion 120 attached to an end of the support portion 70 at the second end E₂. The second plate portion 120 can pivotally support a second arm portion 122 of the second spool-capture portion 76 that is moveable between a first downward position and a second upward position. A fourth bracket portion 124 of the second spool-capture portion 76 can be attached to the first plate portion 120, a fifth bracket portion 126 of the second spool-capture portion 76 can be attached to the second arm portion 122, and a third actuator 128 of the second spool-capture portion 76 can be attached to and extend between the fourth bracket portion 124 and the fifth bracket portion 126. Actuation of the third actuator 128 can be used to move the second arm portion 122 between the first downward position and the second upward position. When in the first downward position, the second spindle portion 92 can be rolled up the second arm portion 122 and ultimately received in a second indentation 130 formed in the second arm portion 122. Thereafter, the second arm portion 122 can be moved from the first downward position to the second upward position, and the second spool-capture portion 76 can be further actuated to capture the second spindle portion 92 using a second locking jaw 132 of the second spool-capture portion 76. To that end, the second locking jaw 132 can be pivotally attached to the second arm portion 122, a sixth bracket portion 134 of the second spool-capture portion 76 can be attached to the second arm portion 122, and a fourth actuator 136 of the second spool-capture portion 76 can be attached to and extend between the second locking jaw 132 and the sixth bracket portion 134. Actuation of the fourth actuator 136 can be used to move the second locking jaw 132 from a disengaged position to an engaged position to capture the second spindle portion 92. With the second arm portion 122 in the second upward position and the second locking jaw 132 engaged, the second spindle portion 92 can be rotated in the second indentation 130 between the second arm portion 122 and the second locking jaw 132.

As depicted in FIGS. 9 and 10, the spool-drive assembly 78 can be attached relative to the second arm portion 122 on the second E₂. The spool-drive assembly 78 can include a motor/engine 140 and a transmission (not shown) for driving rotation of the first spool 80. To that end, the attachment 10 includes a platform portion 142 for supporting the spool-drive assembly 78, and a cover portion 144 for covering portions of the spool-drive assembly 78 including the motor/engine 140 and/or the transmission. The platform portion 142 and the cover portion 144 can provide a housing protecting portions of the spool-drive assembly 78. The spool-drive assembly 78 can include an engageable/disengageable key (not shown) for being extended into or retracted from a keyway (not shown) formed in the second spindle portion 92. When the key is extended into the keyway (and the capture-and-release assembly 72 is locked with the first locking jaw 112 and the second locking jaw 132 in the engaged positions thereof), the key can drive rotation of the first spool 80 via actuation of the spool-drive assembly 78. Furthermore, when the key is retracted from the keyway (and the capture-and-release assembly 72 is unlocked with the first locking jaw 112 and the second locking jaw 132 in the disengaged positions thereof), the first spool 80, as discussed below, can be released from the attachment 10. Alternatively, the spool-driver assembly 78 can include first gearing (not shown) being engageable and disengageable with respect to second gearing (not shown) interconnected with the first spool 80, and, when the first gearing is engaged to the second gearing, the first gearing (via actuation thereof by the spool-drive assembly 78) can drive the second gearing to drive rotation of the first spool 80.

Rotation of the first spool 80 via actuation of the spool-drive assembly 78 can be used to unroll and roll the sheeting 14 from the first spool 80. And using movement of the bulldozer and rotation of the first spool 80 via actuation of the spool-drive assembly 78, the sheeting 14, alternatively, can be unrolled from the first spool 80 and unfurled (to cover) the particular area of ground, or can be rolled onto the first spool 80 and furled (to uncover) the particular area of ground. As such, the sheeting applicator SA provides for efficient deployment and removal of the sheeting 14 relative to the particular area of ground.

The runs R of the tubing 12 can be applied to the particular area of ground by a tubing applicator TA of the attachment. As depicted in FIGS. 1, 2, and FIGS. 7-10, the tubing applicator TA can be supported by a truss support portion including a first truss portion 150 that can be attached to the frame 20 adjacent the first end E₁, and a second truss portion 152 that can be attached to the frame 20 adjacent the second end E₂. Each of the first truss portion 150 and the second truss portion 152 can include a first horizontal portion 154, a second horizontal portion 156, a vertical portion 158, and an angled portion 160.

The first horizontal portion 154 of the first truss portion 150 can extend outwardly from the first side member 26 (FIG. 8), and first horizontal portion 154 of the second truss portion 152 can extend outwardly from the second side member 28 (FIG. 10) in line with the upper first horizontal member 22 and the lower second horizontal member 24. The vertical portion 158 of the first truss portion 150 can extend upwardly from the first side member 26 adjacent the lower second horizontal member 24, and the vertical portion 158 of the second truss portion 152 can extend upwardly from the second side member 28 adjacent the lower second horizontal member 24. The angled portion 160 of the first truss portion 150 can extend upwardly and outwardly from the struts 62A and/or 64A, and the angled portion 160 of the second truss portion 152 can extend upwardly and outwardly from the struts 62B and/or 64B. The second horizontal portion 156 of the first truss portion 150 can extend outwardly from the corresponding first horizontal portion 154, and can be supported by the corresponding vertical portion 158 and the angled portion 160; and the second horizontal portion 156 of the second truss portion 152 can extend outwardly from the corresponding first horizontal portion 154, and can be supported by the corresponding vertical portion 158 and the angled portion 160.

As discussed above, portions of the tubing applicator TA can be supported on either end thereof using the first truss portion 150 and the second truss portion 152. The tubing applicator TA, as depicted in FIG. 1, can include an axle portion 162 having a first end portion 164, a second end portion 166, and a rotatable portion 168 positioned between and rotatable relative to the first end portion 164 and the second end portion 166. As depicted in FIGS. 8 and 10, the first end portion 164 can be supported adjacent the first end E₁ using a first holder 170 attached to an upper surface of the second horizontal portion 156 of the first truss portion 150, and the second end portion 166 can be supported adjacent the second end E₂ using a second holder 172 attached to an upper surface of the second horizontal portion 156 of the second truss portion 152.

The axle portion 162, as depicted in FIGS. 1-10, can rotatably support a multitude of windings 174 of the tubing 12 on the rotatable portion 168, the rotatable portion 168 can be a second (or mandrel) spool, and rotation of the rotatable portion 168 can deploy the windings 174 of the tubing 12 via unrolling thereof, and correspondingly afford placement of the runs R of the tubing 12 over the particular area of ground. The tubing applicator TA can include a first end cap 180 adjacent the first end E₁, a second end cap 182 adjacent the second end E₂, and various dividers 184 separating the windings 174 of the tubing 12. From the rotatable portion 168, the windings 174 of the tubing 12 can be individually fed through a corresponding one of a multitude of flute portions 186 attached to the support member 70 via rotation of the rotatable portion 168. The flute portions 186 can be used in directing the windings 174 of the tubing 12 into the runs R thereof under the sheeting 14. As such, the tubing applicator TA provides for efficient deployment and removal of the runs R of the tubing 12 relative to the particular area of ground.

In one alternative embodiment, rather than using the first end cap 180, the second end cap 182, and the various dividers 184, the rotatable portion 168 of the axle portion 162 can be loaded with various individual spools (not shown) supporting one of the windings 174 of the tubing 12. The various individual spools can then rotate using the rotatable portion 168 to unroll the windings 174 of the tubing 12 to facilitate individually feeding the windings 174 of the tubing through the corresponding one of the multitude of the flute portions 186.

In another alternative embodiment, rather than using the axle portion 162, the various individual spools can be separately supported by individual axles (not shown) in individual cradles (not shown). Each the individual spools supporting one of the windings 174 of the tubing 12 can then rotate using a corresponding one of the individual axles to unroll the windings 174 of the tubing 12 facilitate individually feeding the windings 174 of the tubing through the corresponding one of the multitude of the flute portions 186.

With the attachment 10 attached to the blade of the bulldozer and during movement of the bulldozer, the attachment 10 can be used to coordinate deploying of the runs R of the tubing 12 over the particular area of ground, and deploying of the sheeting 14 over the runs R of the tubing 12 and the particular area of ground. In doing so, the spool-drive assembly 78 can be actuated to unroll the sheeting 14 during movement of the bulldozer, and simultaneously, the windings 174 of the tubing 12 can be unrolled under the sheeting 14 via direction of the flute portions 186. If necessary ends of the sheeting 14 can be pinned to and/or held in place relative to the ground. Furthermore, ends or portions of the windings 174 of the tubing 12 can be attached directly or indirectly to the sheeting 14 so that the unrolling of the sheeting 14 and the windings 174 of the tubing 12 occurs simultaneously via actuation of the sheeting applicator SA and movement of the bulldozer. Alternatively, the ends of the windings 174 of the tubing 12 can be pinned and/or held in place relative to the area ground, and movement of the bulldozer can correspondingly pull the windings 174 from the rotatable portion 168. Either way, the runs R of the tubing 12 can deployed under the sheeting 14 during simultaneous deployment thereof. The process can be reversed to remove the runs R of the tubing 12 and the sheeting 14 from the particular area of ground.

Other embodiments of the invention will be apparent to those skilled in the art from consideration of the specification and practice of the invention disclosed herein.

I claim:

1. An automatic sheeting-and-tubing laying attachment comprising:
a first end and an opposite second end;
a frame extending between the first end and the second end of the automatic sheeting-and-tubing laying attachment, a first adjustable attachment attached to and extending upwardly from the frame, and a second adjustable attachment attached to and extending upwardly from the frame;
a first portion of a support platform portion attached to a lower portion of the frame adjacent the first end of the automatic sheeting-and-tubing laying attachment;
a second portion of the support platform portion attached to the lower portion of the frame adjacent the second end of the automatic sheeting-and-tubing laying attachment;
a first portion of a support truss portion attached to an upper portion of the frame adjacent the first end of the automatic sheeting-and-tubing laying attachment;
a second portion of the support truss portion attached to the upper portion of the frame adjacent the second end of the automatic sheeting-and-tubing laying attachment;
a first spool wound with sheeting rotatably attached relative to the first portion and the second portion of the support platform portion;
a second spool wound with a plurality of runs of tubing rotatably attached relative to the first portion and the second portion of the support truss portion;
a first portion of a capture-and-release assembly attached to at least one of the frame and the first portion of the support platform portion at the first end, the first portion of the capture-and-release assembly being engageable and disengageable to the first spool to facilitate capture and release of a first end portion of the first spool;
a second portion of the capture-and release-assembly attached at least one of the frame and to the second portion of the support platform portion at the second end, the second portion of the capture-and-release assembly being engageable and disengageable to the first spool to facilitate capture and release of a second end portion of the first spool;
a spool-drive assembly attached to one of the first and second portions of the capture-and-release assembly and engageable to a corresponding one of the first end portion and the second end portion of the first spool, the spool-drive assembly being actuatable to rotate the first spool to unfurl or furl the sheeting therefrom;
wherein, when portions of each of the plurality of runs of tubing are attached to the sheeting, rotation of the first spool via actuation of the spool-drive assembly unfurls and furls both the sheeting from the first spool and the runs of tubing from the second spool.

2. The automatic sheeting-and-tubing laying attachment of claim 1, wherein the sheeting and the runs of tubing are deployable over a leach field to facilitate application of leaching solution using the runs of tubing, and prevent evaporation of the leaching solution using the sheeting.

3. The automatic sheeting-and-tubing laying attachment of claim 2, wherein the first adjustable attachment and the second adjustable attachment are blade attachments that facilitate attachment to a blade of a bulldozer to facilitate positioning and repositioning of the automatic sheeting-and-tubing laying attachment.

4. The automatic sheeting-and-tubing laying attachment of claim 3, wherein the frame includes at least a first frame member and a second frame member extending between the first end and the second end, and the first and second portions of the support platform portion, the first and second portions of the support truss portion, the first adjustable blade attachment, and the second adjustable blade attachment each being attached to at least one of the first and second frame members.

5. The automatic sheeting-and-tubing laying attachment of claim 1, wherein portions of each of the first adjustable attachment and the second adjustable attachment are blade attachments that are expandable and contractable to facilitate attachment to a blade of the bulldozer, the automatic sheeting-and-tubing laying attachment being positionable and repositionable after being attached to the bulldozer.

6. The automatic sheeting-and-tubing laying attachment of claim 5, wherein the sheeting and the runs of tubing are deployable over a leach field to facilitate application of leaching solution using the runs of tube, and prevent evaporation of the leaching solution using the sheeting, the bulldozer being usable to move the automatic sheeting-and-tubing laying attachment during deployment of the sheeting and the runs of tubing.

7. The automatic sheeting-and-tubing laying attachment of claim 1, wherein various windings of tubing each corresponding to one of the runs of tubing are wound separately around and spaced apart from one another on the second spool.

8. The automatic sheeting-and-tubing laying attachment of claim 7, wherein the runs of tubing are dispensed from the second spool as the sheeting is dispensed from the first spool during actuation of the spool-drive assembly.

9. The automatic sheeting-and-tubing laying attachment of claim 1, wherein each of the first and second portions of the capture-and-release assembly include an actuatable arm and an actuatable jaw, each of the actuatable arms being attached relative to a corresponding one of the first and second support platform portions and being moveable between a lower first position and an upper second position, each of the actuatable jaws being attached to a corresponding one of the actuatable arms and being moveable between a first disengaged position and a second engaged position.

10. The automatic sheeting-and-tubing laying attachment of claim 1, wherein, when the actuatable arms are in the lower first position,
the first end portion of the first spool can be rolled onto the actuatable arm of the first portion of the capture-and release-assembly,
the second end portion of the first spool can be rolled onto the actuatable arm of the second portion of the capture-and-release assembly,
after receipt of the first and second end portions of the first spool on the actuatable arms, each of the actuatable jaws can be moved from the first disengaged position to the second engaged position to hold the first and second end portions relative to the actuatable jaws; and
the actuatable arms are actuatable to move from the lower first positions to the upper second positions thereof.

11. An automatic sheeting-and-tubing laying attachment comprising:
a first end and an opposite second end;
a frame extending between the first end and the second end of the automatic sheeting-and-tubing laying attachment;
a support platform portion attached to a lower portion of the frame;
a support truss portion attached to an upper portion of the frame;
a first spool wound with sheeting rotatably attached relative to the support platform portion;
a second spool wound with a plurality of runs of tubing rotatably attached relative to the support truss portion;
a first portion and a second portion of a capture-and-release assembly attached to at least one of the frame and the support platform portion, the first and second portions of the capture-and-release assembly being engageable and disengageable to the first spool to facilitate capture and release of a first end portion and a second end portion, respectively, of the first spool, each of the first and second portions of the capture-and release-assembly including an actuatable arm and an actuatable jaw, each of the actuatable arms being attached relative to the support platform portion and being moveable between a lower first position and an upper second position, and each of the actuatable jaws being attached to a corresponding one of the actuatable arms and being moveable between a first disengaged position and a second engaged position;
a spool-drive assembly attached to one of the first and second portions of the capture-and-release assembly and engageable to a corresponding one of the first end portion and the second end portion of the first spool, the spool-drive assembly being actuatable to rotate the first spool to unfurl or furl the sheeting therefrom;
wherein, when the actuatable arms are in the lower first position, the first end portion of the first spool can be rolled onto the actuatable arm of the first portion of the capture-and-release assembly, the second end portion of the first spool can be rolled onto the actuatable arm of the second portion of the capture-and-release assembly, and, after receipt of the first and second end portions of the first spool on the actuatable arms, each of the actuatable jaws can be moved from the first disengaged position to the second engaged position to hold the first and second end portions relative to the actuatable jaws;
wherein, after engagement of the actuatable jaws, the actuatable arms can be moved from the lower first positions to the upper second positions thereof; and
wherein, when portions of each of the plurality of runs of tubing are attached to the sheeting, rotation of the first spool via actuation of the spool-drive assembly unfurls and furls both the sheeting from the first spool and the runs of tubing from the second spool.

12. The automatic sheeting-and-tubing laying attachment of claim 11, wherein the sheeting and the runs of tubing are deployable over a leach field to facilitate application of leaching solution using the runs of tube, and prevent evaporation of the leaching solution using the sheeting, the bulldozer being used to move the automatic sheeting-and-tubing laying attachment during deployment of the sheeting and the runs of tubing.

13. The automatic sheeting-and-tubing laying attachment of claim 11, wherein various windings of tubing each corresponding to one of the runs of tubing are wound separately around and spaced apart from one another on the second spool.

14. The automatic sheeting-and-tubing laying attachment of claim 13, wherein the runs of tubing are dispensed from the second spool as the sheeting is dispensed from the first spool during actuation of the spool-drive assembly.

15. A method of using an automatic sheeting-and-tubing laying attachment comprising:
attaching an automatic sheeting-and-tubing laying attachment to mobile equipment;
moving the automatic sheeting-and-tubing laying attachment relative to a leach field using the mobile equipment;
during the moving of the automatic sheeting-and-tubing laying attachment, rotating a first spool wound with sheeting in a first direction to deploy the sheeting therefrom over the leaching field;
during the moving of the automatic sheeting-and-tubing laying attachment and the rotating of the first spool, rotating a second spool wound with various runs of tubing in a first direction to deploy the various runs of tubing under the sheeting deployed from the first spool and over the leaching field; and
after deployment of the sheeting and the runs of tubing, expelling leaching solution from each of the runs of tubing onto the leaching field to dissolve desirable metals from crushed ore and/or recycled materials forming the leaching field;
wherein the automatic sheeting-and-tubing laying attachment includes a spool-drive assembly engaged to at least one end of the first spool, and actuation of the spool-drive assembly rotates the first spool to deploy the sheeting therefrom;
wherein the various runs of tubing are attached to the sheeting, and the deployment of the sheeting via the moving of the automatic sheeting-and-tubing laying attachment and the actuation of the spool-drive assembly also pulls the various runs of tubing from the second spool; and
wherein each run of the various runs of tubing are spaced from one another under the sheeting.

16. The method of claim 15, further comprising preventing evaporation of the leaching solution using the sheeting applied over the runs of tubing and leaching field.

17. The method of claim 15, wherein the mobile equipment is a bulldozer, and further comprising attaching the automatic sheeting-and-tubing laying attachment to a blade of the bulldozer using at least one blade attachment.

18. The method of claim 17, further comprising attaching the first spool to the automatic sheeting-and-tubing laying attachment using a capture-and-release assembly,
wherein a first portion and a second portion of the capture-and-release assembly are attached on opposite ends of the automatic sheeting-and-tubing laying attachment to engage a first end portion and a second end portion of the first spool.

19. The method of claim 18, wherein each of the first and second portions of the capture and release assembly include an actuatable arm and an actuatable jaw, each of the actuatable arms being moveable between a lower first position and an upper second position, and each of the actuatable jaws being attached to a corresponding one of the actuatable arms and being moveable between a first disengaged position and a second engaged position.

20. The method of claim 19, further comprising:
when the actuatable arms are in the lower first positions, rolling the first end portion of the first spool onto the actuatable arm of the first portion of the capture and release assembly, and rolling the second end portion of the first spool onto the actuatable arm of the second portion of the capture and release assembly; and
after receipt of the first and second end portions of the first spool on the actuatable arms, moving each of the actuatable jaws from the first disengaged position to the second engaged position to hold the first and second end portions relative to the actuatable jaws, and moving each of the actuatable arms from the lower first position to the upper second position.
